(19) United States
(12) Patent Application Publication
(10) Pub. No.: US 2013/0067533 A1
(43) Pub. Date: Mar. 14, 2013

(54) GENERATING A TEST LICENSE FOR A DEVELOPER APPLICATION

(71) Applicants: Sunil Shankar Kadam, Redmond, WA (US); Sanjeev Dwivedi, Sammamish, WA (US); George Li, Bellevue, WA (US); Ariye M. Cohen, Bellevue, WA (US); Alwin Vyhmeister, Seattle, WA (US)

(72) Inventors: Sunil Shankar Kadam, Redmond, WA (US); Sanjeev Dwivedi, Sammamish, WA (US); George Li, Bellevue, WA (US); Ariye M. Cohen, Bellevue, WA (US); Alwin Vyhmeister, Seattle, WA (US)

(73) Assignee: Microsoft Corporation, Redmond, WA (US)

(21) Appl. No.: 13/229,745

(22) Filed: Sep. 11, 2011

(51) Int. Cl. G06F 21/00

(52) U.S. Cl. 726/2

(57) ABSTRACT

One or more techniques and/or systems are disclosed for generating a test application license for a developer application, such as to test a licensing portion of the developer application on a developer machine. An application identifier (appID) can be created that is particular to the developer application. Developer binding data associated with an authenticated developer of the developer application can be created that is particular to the developer. The appID and developer binding data are combined to create bound application developer data. The test application license is generated for the developer application based at least upon an authenticated developer certificate and the bound application developer data. The generated test application license provides for the licensing portion of the developer application to be tested on the developer machine.

### BACKGROUND

Computing devices typically comprise a device platform environment, such as a device operating system, that provides an operating environment in which an application may execute on the device. Often, an application is developed to execute merely in one particular device platform environment, such that a different version of the application may be needed for respective different device platform environments. Further, an executable version of an application can be provided to a computing device in a variety of ways, including via an external data storage component (e.g., disk, portable memory, etc.), a network source connected to the device and/or from an online network site (e.g., website) to which the device has connected.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

Some device platform environments used by a computing device comprise “closed systems”, in which, merely those applications that are certified and/or signed by an authority of the device platform environment, can execute. That is, for example, if a user attempts to execute an unsigned/uncertified application in the device platform environment, the execution may be blocked. An owner of a particular device platform environment may wish to prevent unsigned/uncertified applications from operating for security purposes (e.g., mitigating malicious code) and/or to provide a desirable user experience (e.g., mitigating poorly written code, undesirable programs, etc.).

However, preventing unsigned and/or uncertified applications from executing in the particular device platform can also prevent an application developer from running and testing their applications. For example, a developer may wish to write an application for the particular device platform environment. In this example, prior to certification and deployment (e.g., to an online application store) the developer may wish to test and execute the application in the device platform environment to test for a desirable end-user experience. Further, prior to deployment, the developer may wish to test a licensing portion of the developer application. For example, when issued to an end user, an application typically comprises a user license that can define (e.g., and actively enforce) an end-users ability to use the application. A license can define an expiration of the end-user's user rights (e.g., a time period, number of executions of the application, etc.), and/or can define a type of use (e.g., partial, full, trial, etc.), such as by limiting features allowed to be executed by the end-user.

An online application service to which the developer application may be deployed (e.g., and certified) may wish to control how licenses are issued (e.g., for security purposes), for example. Further, in this example, the online application service may merely allow a developer application deployed to the service to execute if it utilizes an application license issued by the online application service. If the developer wishes to test the licensing portion of the developer application (e.g., to determine that the licensing restrictions work appropriately), prior to certification and deployment to the online application service, the developer may need to get a license from the online application service.

Accordingly, one or more techniques and/or systems are disclosed for a test application license to be generated for an application developer, for example, such that the developer may be able to execute and test a licensing portion of a developer application in a closed system. The test application license may be issued for installation to a machine used by the developer, where the developer is registered and has been authenticated. Further, the test application license may comprise bound application developer data and an authenticated developer certificate identifier that can be validated. If validated, the test application license may merely allow the developer application to execute to test the licensing portion of the developer application.

In one embodiment of generating a test application license for a developer application, bound application developer data can be created. The bound application developer data can comprise an application identifier combined with developer binding data that is associated with an authenticated developer of the developer application. Further, the test application license can be generated for the developer application, where the generating can be based at least upon an authenticated developer certificate and the bound application developer data. The test application license can provide for a licensing portion of the developer application to be tested on a registered developer machine.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow diagram illustrating an exemplary method for generating a test application license for a developer application.

FIG. 2 is a flow diagram illustrating an example embodiment where one or more portions of one or more techniques described herein may be implemented.

FIG. 3 is a flow diagram illustrating an example embodiment where one or more portions of one or more techniques described herein may be implemented.

FIG. 4 is a flow diagram illustrating an example embodiment where one or more portions of one or more techniques described herein may be implemented.

FIG. 5 is a component diagram illustrating an exemplary system for generating a test application license for a developer application.

FIG. 6 is a component diagram illustrating an example embodiment where one or more systems described herein may be implemented.

FIG. 7 is an illustration of an exemplary computer-readable medium comprising processor-executable instructions configured to embody one or more of the provisions set forth herein.

FIG. 8 illustrates an exemplary computing environment wherein one or more of the provisions set forth herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

As provided herein, one or more techniques and/or systems may be devised that provide for an application developer to test an application licensing portion of a developer application, for example, such that the developer application can be appropriately tested prior to deployment. As an illustrative example, a developer that is developing an application for deployment to an online application store may merely be able to test the application's licensing portion if one or more licenses are created for the application. However, for example, in a closed application deployment system, such as the online application store, an application license may not be generated for the application until the application is certified by the online application store (e.g., for security purposes, such as to mitigate malicious license generation). Accordingly, as provided herein, a test application license can be issued for the developer application so that the licensing portion of the developer application can be tested and executed on the developer's machine, for example, prior to deployment.

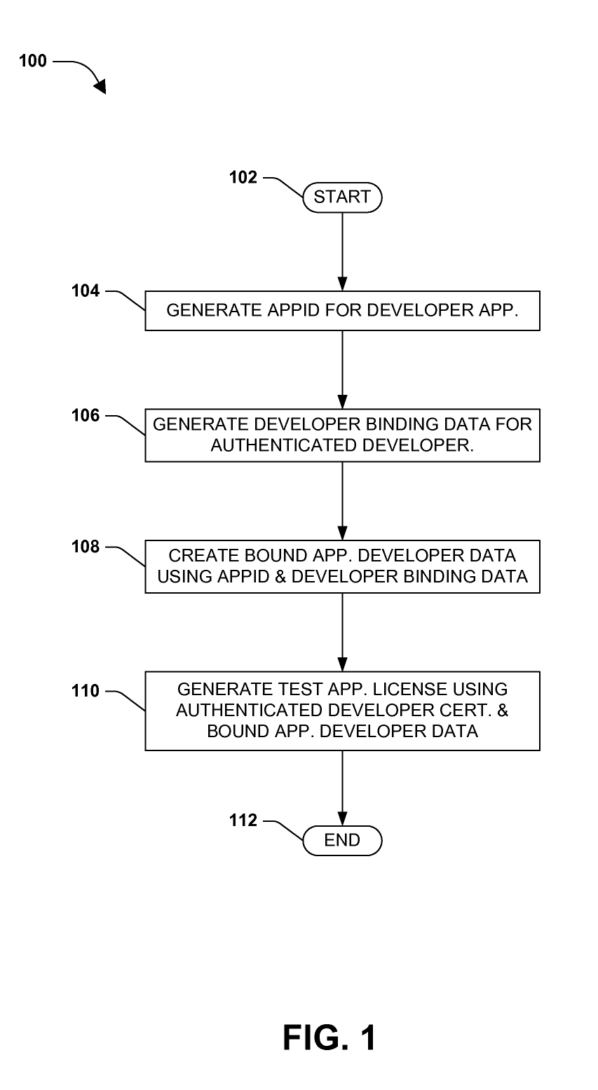

FIG. 1 is a flow diagram illustrating an exemplary method 100 for generating a test application license, which may allow a developer to test a licensing portion of a developer application on developer a machine. As an example, the developer of an application intended for deployment to an online application service may wish to provide for the use of one or more application licenses for their application. As an illustrative example, the developer may write an application that they can sell via an online application store. Application license enforcement is one way that the developer may be able to mitigate unwanted use of their application (e.g., unlicensed copies may not execute properly).

During development of the application (e.g., prior to deployment to the online application service) the developer may wish to test a license enforcement portion of the developer application, for example. Further, the online application service may wish to limit an ability of developers to create their own licenses for the applications intended to be deployed to the online application service (e.g., for security purposes). By providing for the test application license to be generated for the developer to use in testing the license enforcement portion of the developer application, the online application service may be able to control how application licenses are issued, and to whom they are issued.

The exemplary method 100 begins at 102 and involves generating an application identifier (appID) for the developer application, at 104. As an example, an appID can comprise an identifier (e.g., number, alpha-numeric sequence, string, etc.) that is specific to the application for the online application service to which the developer application is intended to be deployed. As an illustrative example, the online application service may comprise an online application store, and the application store may use the appID to distinguish between applications deployed to the store for distribution to users and/or being developed for the application store. In one embodiment, the online application service may provide the developer application appID, for example, when the developer registers the developer application with the online application service. In this example, the online application service may generate the appID, or the appID may be generated for the online application service.

At 106, binding data can be generated for an authenticated developer. For example, a developer may be authenticated with a service using a user identification (userID) associated with the developer. The userID may have been created (e.g., or registered) when a user registered as a developer with the online application service. In this example, during the developer registration processes with the service the user may provide personal identification information to identify the user to the service. In this way, for example, one or more portions of the personal identification information associated with authenticated developer (e.g., userID, name, location, IP address, registration date, etc.) may be used as the developer binding data.

At 108, bound application developer data can be created by combining the appID, for the developer application, with the developer binding data associated with the authenticated developer of the developer application. Combining the appID with the developer binding data can create a type of identifier that links the developer with their developer application, for example, which may be more difficult for a malicious user to recreate and/or modify (e.g., for use with a different application). In one embodiment, the appID and the developer binding data (e.g., and one or more other identifiers) may be combined into a file that may not be modified.

At 110, the test application license is generated for the developer application using an authenticated developer certificate and the bound application developer data. The test application license provides for a licensing portion of the developer application to be tested on a registered developer machine. Using the test application license, for example, the authenticated developer may be able to test and/or execute the license enforcement portion of the developer application on their registered machine (e.g., personal computer), before deploying the application for use by the online application service (e.g., making the application available on an online application store). Having generated the test application license, the exemplary method 100 ends at 112.

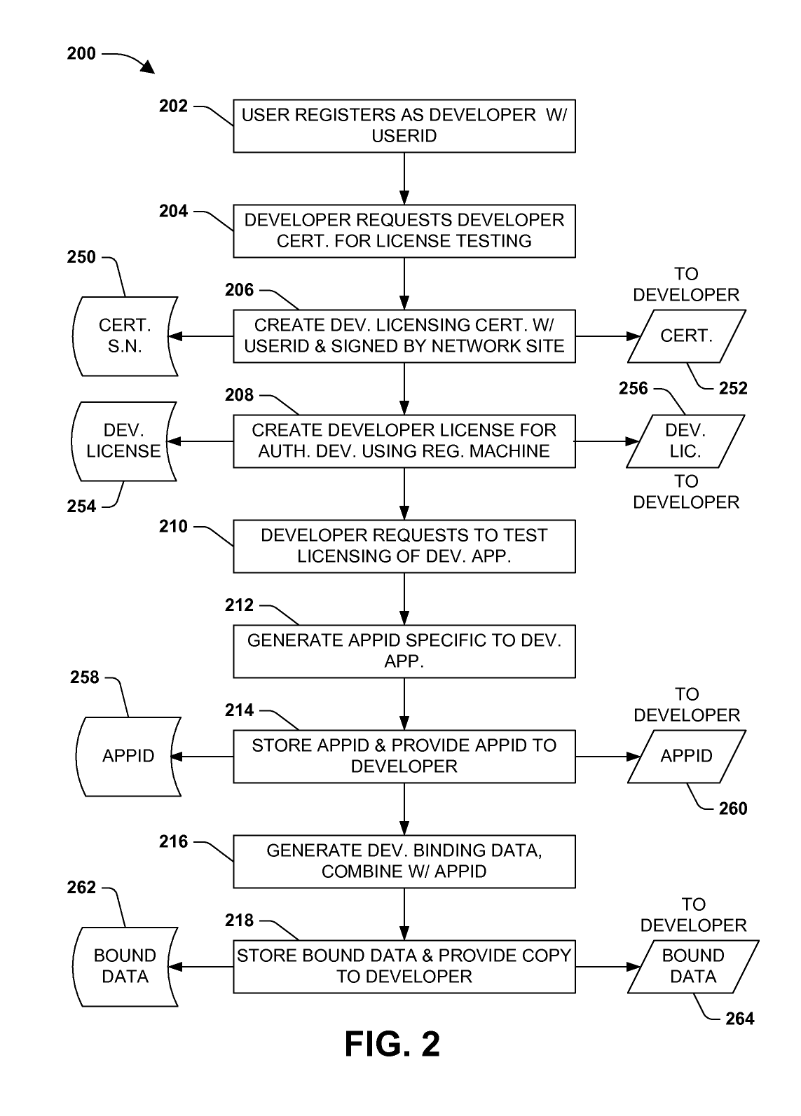

FIG. 2 is a flow diagram illustrating an example embodiment 200 where one or more portions of one or more techniques described herein may be implemented. At 202, a user can register as a developer using a registered userID. As an example, the user may have registered the userID with an online service, where personal identification information is provided to the online service in exchange for registering the userID to the user. In this example, the registered user may utilize the registered userID to register as a developer, such as with an online application service (e.g., associated with the online service). In this way, for example, the personal identification information provided for the registered userID can be associated with registering the user as a developer for the online application service (with which the user is registering).

At 204, the developer can request a developer licensing certificate that may be used to sign a developer application (e.g., an application developed by the registered developer, such as for deployment to the online application service); and/or may be used to identify that the developer application is authorized for testing the licensing portion thereof. A developer licensing certificate can comprise a digital document that indicates the identity of the developer (e.g., like a written signature on a document), where the identity has been verified by a trusted authority issuing the certificate. In this way, for example, when the developer certificate is used to sign an application it can identify the owner/developer/author of the application; and indicate that the identity has been verified by the trusted authority (e.g., if the certificate is authenticated).

At 206 in the example embodiment 200, the developer licensing certificate can be created for the developer. In one embodiment, the developer licensing certificate can be rooted in a verified certificate for an online network site, such as associated with the online application service generating the test application license (e.g., an online application store). In this embodiment, for example, rooting the developer certificate in the verified certificate for the online network site can provide the “trusted authority” used to verify the identity of the developer requesting the developer licensing certificate. Further, the developer licensing certificate can comprise an indication that the developer application is authorized for testing the licensing portion of the developer application.

A copy of the developer licensing certificate can be provided to the developer 252, for example, for use by the developer to sign the developer application. In one embodiment, the generated developer licensing certificate can be stored locally on a registered developer machine. Additionally, a serial number (e.g., or other identifier) associated with the developer certificate can be stored remotely 250 from the registered developer machine (e.g., by the online application service), for example, for use in subsequent certificate authentication (e.g., retrievable from a database identifying valid certificates).

At 208 in the example embodiment 200, a developer license can be generated for the developer. For example, the developer license can comprise a document that allows an authenticated developer to run their developer application on a registered developer machine. In a closed system, such as for the online application service that provides applications that merely execute in a particular device platform environment (e.g., operating system (OS)), for example, the developer may need the developer license to write, test and/or execute the developer application prior to being certified by the online application service.

In one embodiment, the developer license can comprise credentials, such as the registered developer's userID, a hardwareID for the registered developer machine, and/or a developer certificate (e.g., a certificate that identifies the developer for the developer application, which may be different than the developer licensing certificate). In one embodiment, one or more of the credentials may be provided by the registered developer and/or identified on the developer machine, and used to create the developer license. The developer license can be provided to the developer 256 (e.g., stored on the developer machine), and/or may be stored remotely 254, such as by the online application service (e.g., for subsequent authentication purposes).

At 210 in the example embodiment 200, the developer can request to test the licensing portion of the developer application. For example, the developer may submit a request to the online application service to be permitted to test licensing enforcement for their developer application. Licensing enforcement can provide for the developer to merely allow those end-users that hold an appropriate application license to execute one or more portions of the developer application. For example, an application license can be used to “turn on” or “turn off” one or more features of an application, based on the end-user's authority to execute the application granted by the license.

At 212, an application identifier (appID) can be generated that is specific to the developer application. As an example, a first appID can be used by the online application service to identify a first developer application, and a second appID can be used to identify a second developer application. In one embodiment, the appID may comprise a next available identifier (e.g., unassigned) from a string sequence of identifiers. In one embodiment, the appID may comprise a generated string sequence (e.g., number, alphanumeric sequence, etc.), for example, where the sequence is generated by one or more functions that generate a non-colliding set of IDs.

In one embodiment, the appID can be provided to the developer 260, for example, to be stored locally on the developer machine. In one embodiment, the appID can be stored remotely 258 from the developer machine, such as by the online application service. As an example, the remotely stored appID 258 may be used for authentication/verification purposes, such as to compare with an appID submitted by a developer.

At 216 in the example embodiment 200, developer binding data, comprising information associated with the authenticated developer, can be generated. For example, the developer binding data can comprise one or more portions of information associated with the registered developer, such as personal identification information that is specific to the developer (e.g., userID, name, location, IP address, other identifiers, etc.). Further, the developer binding data can be combined with the appID to create bound application developer data.

In one embodiment, creating the bound application developer data can comprise combining the appID with the developer binding data into a unit of data that mitigates separation of the appID from the developer binding data. As an example, the one or more portions of information associated with the registered developer can be combined with the appID in such a way (e.g., in a file or document that does not provide for alterations without being noticed) as to mitigate the separation of the data. For example, a malicious user may wish to modify the bound application developer data to use with a different application. In this example, by creating a bound unit of data, may make it difficult for a malicious user to misuse the bound data.

In one embodiment, a first copy of the bound application developer data can be provided to the authenticated developer 264. In one embodiment, a second copy of the bound application developer data can be stored remotely 262 from the developer machine. As an example, the second copy may be used for verification purposes (e.g., subsequently), to compare with (e.g., locally stored) bound application developer data submitted for authentication.

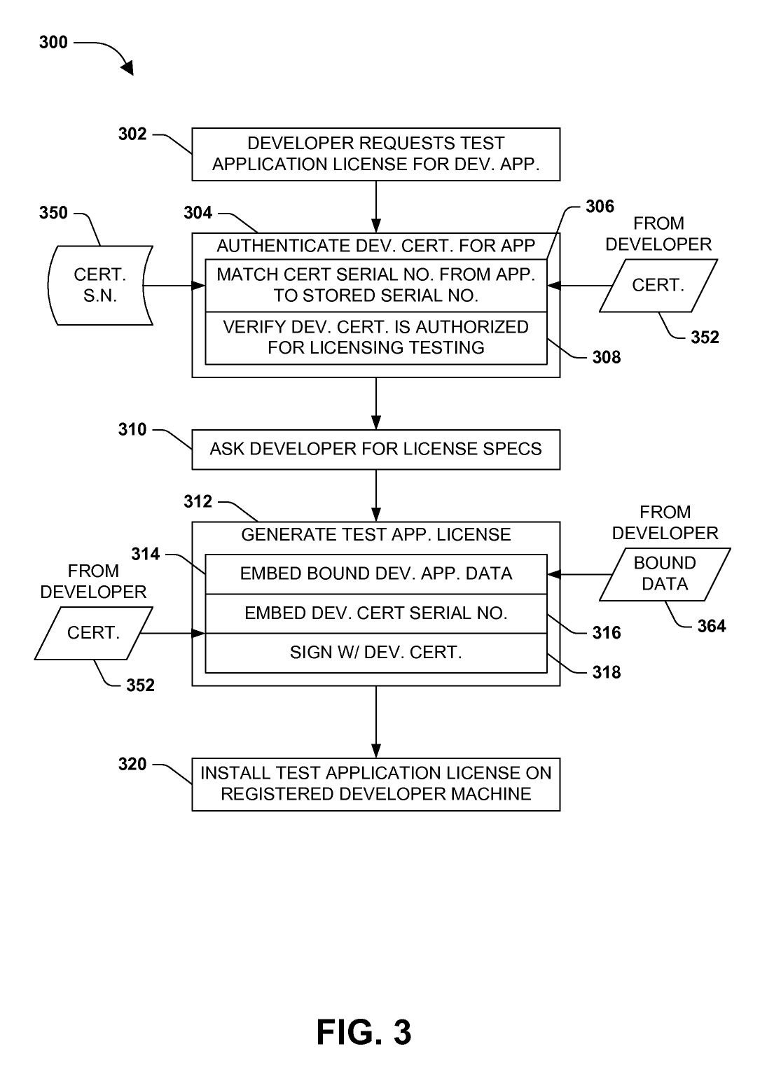

FIG. 3 is a flow diagram illustrating an example embodiment 300 one or more portions of one or more techniques described herein. At 302, a registered developer can request a test application license for a developer application. For example, a test license creation tool (e.g., an application programming interface (API), or program) may be made available to the registered developer (e.g., loaded on the developer machine, or accessed remotely) to create the test application license for the developer application. In this example, the registered developer can activate the test license creation tool from their developer machine and request creation of the test application license (e.g., by selecting a user interface control element requesting a new license).

At 304, a developer licensing certificate 352 can be authenticated, resulting in an authenticated developer certificate. For example, the developer application can be signed by a developer certificate created for the registered developer (e.g., at 206 of FIG. 2) and provided to the developer (e.g., at 252 or FIG. 2) for signing the developer application. As described above, the developer certificate can provide a type of trusted identity for the developer, for example, if the certificate is authenticated. In one embodiment, the developer can sign the developer application with the developer licensing certificate 352, and if the developer application is signed by the developer licensing certificate, an identification (e.g., serial number) associated with the developer licensing certificate may be identified, for example.

At 306, in order to determine whether the signing developer licensing certificate 352 is authenticated the certificate's serial number (e.g., or other identifier) can be compared with stored serial numbers 350 of valid developer certificates (e.g., stored on a remote server by the licensing service). Further, at 308, if the developer licensing certificated is authenticated, it may be determined whether the resulting authenticated developer certificate is authorized for testing the licensing portion of the developer application (e.g., as opposed to being authorized for some other purpose(s)). As an illustrative example, the authenticated developer certificate may comprise an object identifier (OID) that marks the certificate as valid for creating a test application license for the developer application (e.g., or some other identifier validating the certificate for creating a test application license).

In this example embodiment 300, at 310, if the developer licensing certificate is authenticated for the developer application, the registered developer may provide one or more licensing specifications for the test application license. In one embodiment, the test license creation tool, described above, may provide for the user to select and/or input one or more specifications. In this embodiment, the one or more specifications may comprise a license expiration that is associated with the developer application and/or a license type associated with the developer application.

As an example, an application license can comprise an expiration, after which the application may no longer execute. In this embodiment, the registered developer may wish to test one or more license expiration aspects of the developer application, for example, and can select an expiration for the test application license (e.g., a date, a time period, a number of application uses, or some other expiration specification). Further, an application license can comprise a “type,” for example, which may indicate how the application can be used by an end-user (e.g., unlimited use of features, use limited to merely some features, use by more than one end-user, etc.). In this embodiment, the registered developer may wish to test one or more license type aspects of the developer application, for example, and can select the license type for the test application license (e.g., full license, limited use license, multi-user license, trial license, etc.).

At 312 of the example embodiment 300, the test application license can be generated. At 314, generating the test application license can comprise embedding bound application developer data 364 in the test application license. Further, at 316, generating the test application license can comprise embedding an identifier (e.g., serial number) associated with the authenticated developer certificate 352 in the test application license. As an example, the developer can provide the authenticated developer certificate 352 and bound application developer data 364 to the test license creation tool. In this example, the serial number of the certificate and the bound application developer data can be embedded into the certificate in a way that mitigates alteration of the certificate (e.g., modifying the serial number and/or the bound application developer data).

At 320, the generated test application license can be installed on the registered developer machine. In one embodiment the registered developer machine can be authenticated for use by the authenticated developer to test the licensing portion of the developer application. As an example, a developer machine, such as a personal computing device used by the registered developer, may comprise a hardwareID that is specific to the developer machine. Further, the registered developer can register their developer machine with the online application service, for example, so that the registered developer machine can be used to develop an application for use by the online application service, and test the licensing portion of the developer application.

During the developer machine registration, for example, the hardwareID for the developer machine may be stored (e.g., on a server remotely situated from the developer machine) by the online application service for authentication purposes (e.g., for subsequent comparison with a hardwareID submitted for authentication). Further, in this example, when the registered developer wishes to install the test application license on the registered developer machine, the online application service may obtain the hardwareID from the developer machine. The obtained hardwareID can be compared to the hardwareID stored for authentication purposes by the online application development service, for example, to authenticate the registered developer machine comprising the hardwareID (e.g., see if the obtained hardwareID and the stored hardwareID match).

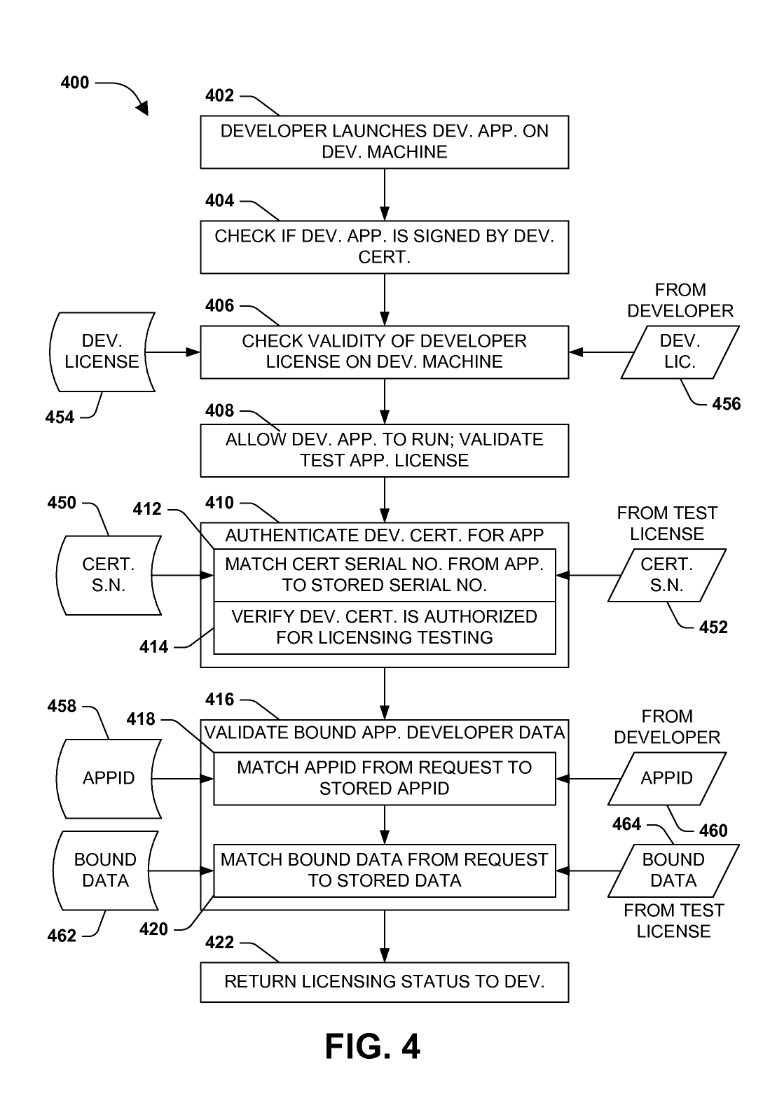

FIG. 4 is a flow diagram illustrating an example embodiment 400 where one or more portions of one or more techniques described herein may be implemented, such as where a test application license may be tested by a developer. At 402, the developer can launch a developer application on an authenticated developer machine, on which the test application license was installed.

At 404, the developer application can be checked to determine if it is signed by a developer certificate. As described above (e.g., at 304 of FIG. 3) a developer certificate can be issued to a registered developer, and it can be used to sign the developer application, for example, to provide a trusted identity for the developer. In this embodiment, for example, the developer application may need to be signed by an authenticated developer certificate in order to execute on the registered developer machine.

At 406, a developer license 456 comprised on the developer machine can be validated. As an example, when the developer license is generated (e.g., at 208 of FIG. 2) for the developer attempting to test their developer application, the generated developer license may be stored locally in a developer license cache. In this example, the development license cache can be searched for the developer license 456. In one embodiment, the developer may provide the developer license 456 (e.g., upon request), or may provide a location in which the developer license 456 is stored on the developer machine.

In this embodiment, for example, if the developer license 456 is identified on the developer machine and/or provided by the developer, the identified developer license 456 can be validated. Validating the developer license 456 can comprise validating information comprised in the developer license 456, such as an authenticated userID, an authenticated hardwareID, the authenticated developer certificate, and/or a certified signature. As an example, the information comprised in the developer license 456 can be compared with stored developer license validation information 454 for the device and/or developer in order to validate the developer license 456.

At 408, if the developer license is validated, the developer application may be allowed to run on the registered developer machine. Further, in this embodiment 400, running the developer application can comprise testing the licensing portion of the developer application. Testing the licensing portion of the developer application can comprise validating the test application license installed on the registered developer machine.

At 410, validating the test application license can comprise authenticating a developer licensing certificate, comprised in the test application license, for the developer application. As described above (e.g., at 304 of FIG. 3), for example, a serial number from the developer licensing certificate 452 can be compared with one or more stored serial numbers 450 from valid developer certificates, at 412. If the developer licensing certificate is identified as an authenticated developer certificate, it may be determined, at 414, whether the developer licensing certificate is authorized for licensing testing. As an example, the authenticated developer licensing certificate 452 can comprise an OID that indicates the certificate is valid for test application license use.

At 416, if the developer licensing certificate is authenticated, bound application developer data 464, which may be embedded in the test application license installed on the registered developer machine, can be validated. In one embodiment, a licensing component associated with the developer application may receive a request to validate the test application license, where the request comprises a copy of the bound application developer data (e.g., from a developer copy, at 264 of FIG. 2), and an appID for the developer application.

As an illustrative example, when the registered developer launches the developer application (e.g., after checking the developer certificate and developer license), the developer application may send a request to the licensing component to validate the test application license for the application. In this example, the request can comprise the appID 460 of the developer application and the bound data for the test application license. In this way, in this example, the licensing portion of the developer application may be tested to determine if it functions according to a design of the developer.

At 418, validating the bound application developer data can comprise matching the appID 460 from the validation request to a stored appID 458 (e.g., 258 of FIG. 2). At 420, the bound application developer data 464 provided in the validation request can be matched to identified bound application developer data 462 associated with the developer application, for example, stored for validation purposes.

At 422, if the bound application developer data is validated, a appropriate licensing status can be returned to the developer application. As an example, if the test application license that is installed on the registered developer machine is validated (e.g., by the licensing tool), the developer application may be allowed to run in accordance with specified limitations for the license, such as an expiration and/or a type of license. As an illustrative example, the test application license may comprise a sixty day expiration, and may comprise a trial version that merely allows certain features of the application to execute. In this example, the licensing tool may return the expiration and features limits to the developer application upon validation of the test application license. In this way, for example, the developer may be able to test that the licensing portion of the developer application executes appropriately.

A system may be devised that allows a developer to test and/or execute a licensing portion of a developer application on the developers computer, for example, where the developer application may be configured to be deployed to an online application service. For example, if the particular device platform environment is a “closed-type” platform, the developer application may need to be certified by online application service before it can be deployed. A test application license can be generated that allows the developer to test and/or execute the developer application, and in particular licensing portions thereof, on the developer's computer, for example, where the license can be validated at runtime of the developer application.

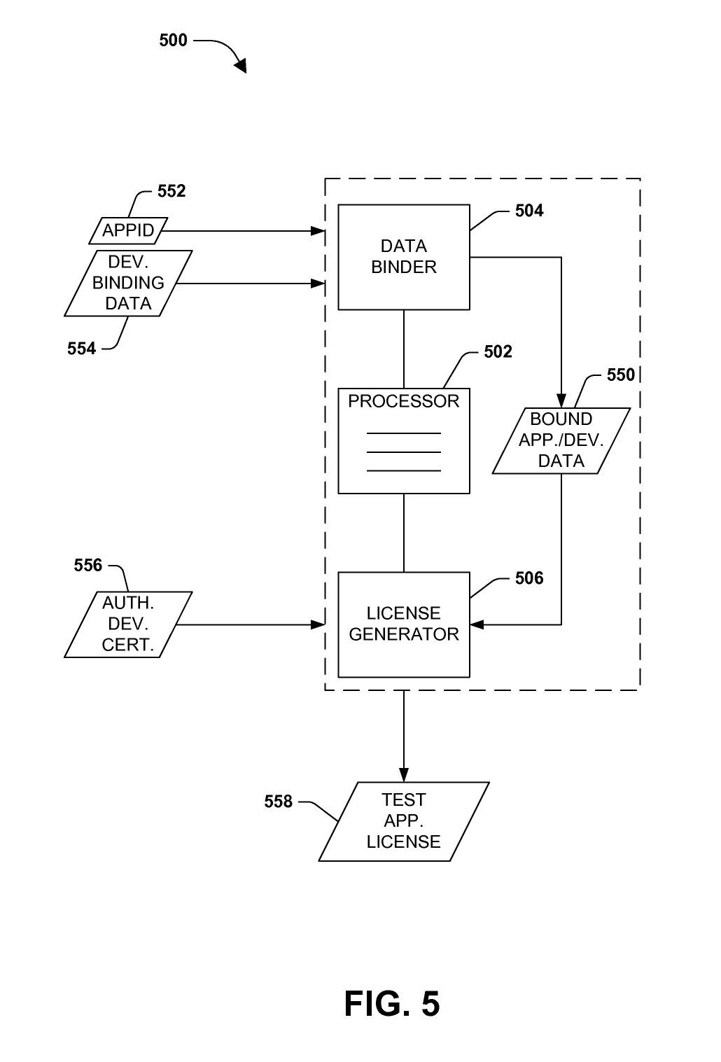

FIG. 5 is a component diagram illustrating an exemplary system 500 for generating a test application license for a developer application, for example that may allow a developer to test a licensing portion of a developer application on a developer machine. The exemplary system 500 comprises a computer-based processor 502 that is configured to process data for the system. The processor 502 is operably coupled with a data binding component 504 that is configured to create bound application developer data 550. The bound application developer data 550 comprises an application identifier 552 (appID) that is combined with developer binding data 554 associated with an authenticated developer of the developer application.

The exemplary system 500 further comprises a license generation component 506 that is operably coupled with the processor 502. The license generation component 506 is configured to generate the test application license 558 for the developer application, where the generation of the test application license is based at least upon an authenticated developer certificate 556 and the bound application developer data 550 provided by the data binding component 504. The test application license 558 generated by the license generation component 506 provides for testing the licensing portion of the developer application on a registered developer machine.

In one embodiment, the test application license can be configured to allow the developer application to execute in a device platform environment that is supported by an online application service. In this embodiment, the online application service may provide one or more applications from one or more developers, where the one or more applications are for use in the device platform environment. As an illustrative example, the device platform environment may comprise an operating system configured for a particular type of computing device. In this example, the one or more applications, created by the one or more developers, may be written merely for use in the operating system used by the particular type of computing device.

Further, in this example, the online application service may comprise a web-based service that provides the applications to users, where an application needs to be certified (e.g., for security purposes) by the web-based service before it can be made available by the web-based service. In this example, prior to certification and deployment to the web-based service, the developer may wish to test and/or execute the licensing portion of the developer application on their own developer machine. The exemplary system 500 may be used to generate the test application license that allows the developer to test and/or execute the licensing portion of the developer application on their own developer machine prior to certification and deployment to the web-based service, for example, by generating the test application license for installation onto the developer machine.

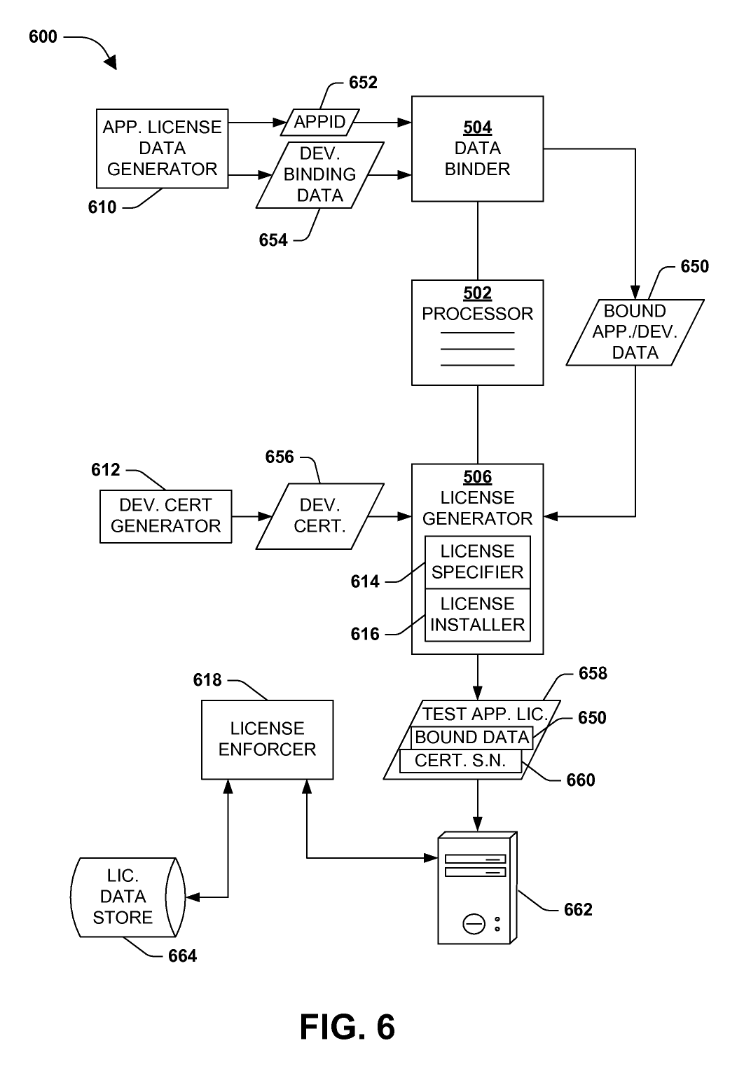

FIG. 6 is a component diagram illustrating an example embodiment 600 where one or more portions of one or more systems described herein may be implemented. In this example 600, an extension of FIG. 5 is provided and thus description of elements, components, etc. described with respect to FIG. 5 may not be repeated at least for simplicity. In this embodiment 600, a test application license 658 can comprise bound application developer data 650, comprising an appID 652 and developer binding data 654 combined into a unit of data that mitigates separation of the appID 652 from the developer binding data 654. Further, the test application license 658 can comprise a serial number 660 (e.g., or other identifier) that is associated with an authenticated developer certificate.

An application licensing data generation component 610 can be configured to generate the appID 652, comprising an identifier merely associated with a developer application, and/or generate the developer binding data 654, comprising information associated with an authenticated developer. In this embodiment, the appID 652 and developer binding data 654 can be combined by the data binding component 504 to generate the bound application developer data 650 (e.g., into a file that mitigates data separation) embedded into the test application license, for example.

A developer certificate generation component 612 can be configured to generate a developer licensing certificate 656 for use in signing the developer application. The developer licensing certificate 656 may be valid for testing a licensing portion of the developer application on a registered developer machine. Further, the developer licensing certificate 656 can be authenticated, such as by the license generation component 506, resulting in the authenticated developer certificate, for example.

In the example embodiment 600, the license generation component 506 can comprise a license specification component 614 that is configured to provide for the authenticated developer to select one or more specifications for the generation of the test application license 658. In one embodiment, the license specification component 614 may provide for the developer to specify a license expiration associated with the test application license 658 (e.g., a time period, use limit, etc.), and/or a license type associated with the test application license 658 (e.g., full, limited, trial, etc.).

Further, the license generation component 506 can comprise a license installing component 616 that is configured to facilitate installation of the test application license 658 on the registered developer machine 662. In one embodiment, the registered developer machine 662 can be authenticated for use by the authenticated developer to test the licensing portion of the developer application.

In the example embodiment 600, a license enforcement component 618 can be configured to validate the test application license 658, for example, upon execution of the developer application on the registered developer machine 662. In one embodiment, the license enforcement component 618 can be configured to validate a first copy of the bound application developer data 650, comprised in the test application license 658, by comparing the first copy with a second copy of the bound application developer data stored in a license data store 664. In one embodiment, the first copy of the bound application developer data 650 can be received in a request to validate the test application license 658, and the second copy of the bound application developer data can be stored as a validation copy in the license data store 664, for example.

Further, the license enforcement component 618 can be configured to validate a developer license that is issued to the authenticated developer for testing the licensing portion of the developer application on the registered developer machine 662, for example, by validating information comprised in the developer license. The license enforcement component 618 may also be configured to verify that the developer application is signed by the authenticated developer certificate. Additionally, the license enforcement component 618 can be configured to validate a first identifier associated with the authenticated developer certificate (e.g., the serial number), where the first identifier is comprised in the test application license 658, and compare the first identifier with a second identifier (e.g., serial number) associated with the authenticated developer certificate, where the second identifier is comprised in the validated developer license (e.g., identified in the license data store 664).

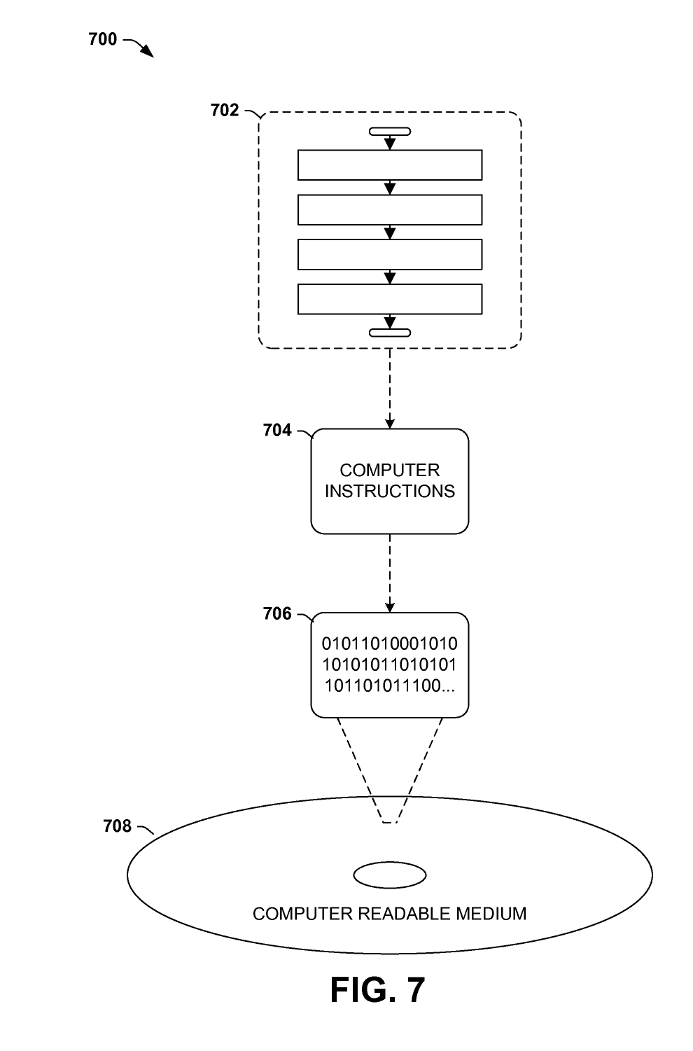

Still another embodiment involves a computer-readable medium comprising processor-executable instructions configured to implement one or more of the techniques presented herein. An exemplary computer-readable medium that may be devised in these ways is illustrated in FIG. 7, wherein the implementation 700 comprises a computer-readable medium 708 (e.g., a CD-R, DVD-R, or a platter of a hard disk drive), on which is encoded computer-readable data 706. This computer-readable data 706 in turn comprises a set of computer instructions 704 configured to operate according to one or more of the principles set forth herein. In one such embodiment 702, the processor-executable instructions 704 may be configured to perform a method, such as at least some of the exemplary method 100 of FIG. 1, for example. In another such embodiment, the processor-executable instructions 704 may be configured to implement a system, such as at least some of the exemplary system 500 of FIG. 5, for example. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

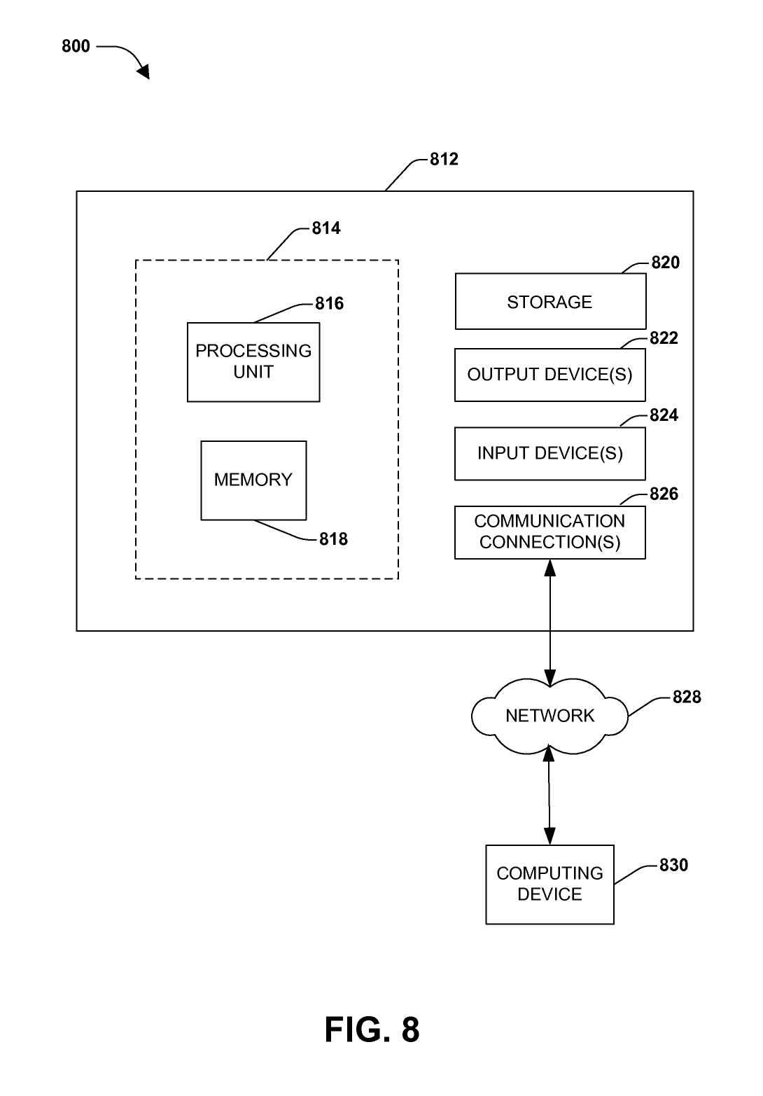

FIG. 8 and the following discussion provide a brief, general description of a suitable computing environment to implement embodiments of one or more of the provisions set forth herein. The operating environment of FIG. 8 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 8 illustrates an example of a system 800 comprising a computing device 812 configured to implement one or more embodiments provided herein. In one configuration, computing device 812 includes at least one processing unit 816 and memory 818. Depending on the exact configuration and type of computing device, memory 818 may be volatile (such as RAM, for example), non-volatile (such as ROM, flash memory, etc., for example) or some combination of the two. This configuration is illustrated in FIG. 8 by dashed line 814.

In other embodiments, device 812 may include additional features and/or functionality. For example, device 812 may also include additional storage (e.g., removable and/or non-removable) including, but not limited to, magnetic storage, optical storage, and the like. Such additional storage is illustrated in FIG. 8 by storage 820. In one embodiment, computer readable instructions to implement one or more embodiments provided herein may be in storage 820. Storage 820 may also store other computer readable instructions to implement an operating system, an application program, and the like. Computer readable instructions may be loaded in memory 818 for execution by processing unit 816, for example.

The term “computer readable media” as used herein includes computer storage media. Computer storage media includes volatile and nonvolatile, removable and non-removable media implemented in any method or technology for storage of information such as computer readable instructions or other data. Memory 818 and storage 820 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 812. Any such computer storage media may be part of device 812.

Device 812 may also include communication connection(s) 826 that allows device 812 to communicate with other devices. Communication connection(s) 826 may include, but is not limited to, a modem, a Network Interface Card (NIC), an integrated network interface, a radio frequency transmitter/receiver, an infrared port, a USB connection, or other interfaces for connecting computing device 812 to other computing devices.

Communication connection(s) 826 may include a wired connection or a wireless connection. Communication connection(s) 826 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 812 may include input device(s) 824 such as keyboard, mouse, pen, voice input device, touch input device, infrared cameras, video input devices, and/or any other input device. Output device(s) 822 such as one or more displays, speakers, printers, and/or any other output device may also be included in device 812. Input device(s) 824 and output device(s) 822 may be connected to device 812 via a wired connection, wireless connection, or any combination thereof. In one embodiment, an input device or an output device from another computing device may be used as input device(s) 824 or output device(s) 822 for computing device 812.

Components of computing device 812 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 812 may be interconnected by a network. For example, memory 818 may be comprised of multiple physical memory units located in different physical locations interconnected by a network.

Those skilled in the art will realize that storage devices utilized to store computer readable instructions may be distributed across a network. For example, a computing device 830 accessible via network 828 may store computer readable instructions to implement one or more embodiments provided herein. Computing device 812 may access computing device 830 and download a part or all of the computer readable instructions for execution. Alternatively, computing device 812 may download pieces of the computer readable instructions, as needed, or some instructions may be executed at computing device 812 and some at computing device 830.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Further, At least one of A and B and/or the like generally means A or B or both A and B. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A computer-based method for generating a test application license for a developer application, comprising:
creating bound application developer data by combining an application identifier (appID) with developer binding data associated with an authenticated developer of the developer application; and
generating the test application license for the developer application, the test application license providing for a licensing portion of the developer application to be tested on a registered developer machine, the generating based at least upon an authenticated developer certificate and the bound application developer data, at least some of the creating and the generating implemented at least in part via a processing unit.

2. The method of claim 1, comprising one or more of:
generating the appID comprising an identifier merely associated with the developer application; and
generating the developer binding data comprising information associated with the authenticated developer.

3. The method of claim 1, creating the bound application developer data comprising combining the appID with the developer binding data into a unit of data that mitigates separation of the appID from the developer binding data.

4. The method of claim 1, comprising one or more of:
providing a first copy of the bound application developer data to the authenticated developer; and
storing a second copy of the bound application developer data.

5. The method of claim 1, comprising authenticating a developer licensing certificate resulting in the authenticated developer certificate, the developer licensing certificate generated for use by the authenticated developer in testing the licensing portion of the developer application.

6. The method of claim 1, generating the test application license based at least upon one or more of:
a license expiration associated with the developer application; and
a license type associated with the developer application.

7. The method of claim 1, comprising generating the test application license merely if the developer application is signed by the authenticated developer certificate.

8. The method of claim 1, generating the test application license comprising embedding the bound application developer data and an identifier associated with the authenticated developer certificate in the test application license.

9. The method of claim 1, comprising installing the test application license on the registered developer machine, the registered developer machine authenticated for use by the authenticated developer to test the licensing portion of the developer application.

10. The method of claim 4, comprising receiving a request to validate the test application license, the request comprising the first copy of the bound application developer data.

11. The method of claim 10, comprising validating the first copy of the bound application developer data received in the request by comparing the first copy of the bound application developer data with the second copy of the bound application developer data.

12. The method of claim 1, comprising validating the test application license, comprising one or more of:
validating a developer license issued to the authenticated developer for testing the licensing portion of the developer application on the registered developer machine;
verifying that the developer application is signed by the authenticated developer certificate;
validating a first identifier associated with the authenticated developer certificate, the first identifier comprised in the test application license; and
comparing the first identifier with a second identifier associated with the authenticated developer certificate, the second identifier comprised in the developer license.

13. A system for generating a test application license for a developer application, comprising:
a computer-based processor configured to process data for the system;
a data binding component, operably coupled with the processor, configured to create bound application developer data, the bound application developer data comprising an application identifier (appID) combined with developer binding data associated with an authenticated developer of the developer application; and
a license generation component, operably coupled with the processor, configured to generate the test application license for the developer application based at least upon an authenticated developer certificate and the bound application developer data, the test application license providing for testing a licensing portion of the developer application on a registered developer machine.

14. The system of claim 13, the test application license comprising:
the bound application developer data comprising the appID and the developer binding data combined into a unit of data that mitigates separation of the appID from the developer binding data; and
a serial number associated with the authenticated developer certificate.

15. The system of claim 13, the test application license configured to allow the developer application to execute in a device platform environment supported by an online application service that provides one or more applications from one or more developers.

16. The system of claim 13, comprising an application licensing data generation component, configured to perform one or more of:
generate the appID comprising an identifier merely associated with the developer application; and
generate the developer binding data comprising information associated with the authenticated developer.

17. The system of claim 13, comprising a developer certificate generation component configured to generate a developer licensing certificate for use in signing the developer application, the developer certificate valid for testing the licensing portion of the developer application on the registered developer machine.

18. The system of claim 13, the license generation component comprising one or more of:
a license specification component configured to provide for the authenticated developer to select one or more specifications for the generation of the test application license, the one or more specifications comprising at least one of:
a license expiration associated with the test application license; and
a license type associated with the test application license; and
a license installing component configured to facilitate installation of the test application license on the registered developer machine, the registered developer machine authenticated for use by the authenticated developer to test the licensing portion of the developer application.

19. The system of claim 13, comprising a license enforcement component configured to perform one or more of:
validate a first copy of the bound application developer data by comparing the first copy with a second copy of the bound application developer data, the first copy received in a request to validate the test application license, the second copy stored as a validation copy;
validate a developer license issued to the authenticated developer for testing the licensing portion of the developer application on the registered developer machine;
verify that the developer application is signed by the authenticated developer certificate;
validate a first identifier associated with the authenticated developer certificate, the first identifier comprised in the test application license; and
compare the first identifier with a second identifier associated with the authenticated developer certificate, the second identifier comprised in the developer license.

20. A computer readable medium comprising computer executable instructions that when executed via a processor on a computer perform a method for generating a test application license for a developer application, comprising:
generating an application identifier (appID) comprising an identifier merely associated with the developer application;
generating developer binding data comprising information associated with an authenticated developer;
generating bound application developer data comprising combining the appID with the developer binding data into a unit of data that mitigates separation of the appID from the developer binding data;
authenticating a developer licensing certificate resulting in an authenticated developer certificate, the developer licensing certificate generated for use by the authenticated developer in testing a licensing portion of the developer application; and
generating the test application license for the developer application merely if the developer application is signed by the authenticated developer certificate, the test application license providing for the licensing portion of the developer application to be tested on a registered developer machine, the generating the test application license comprising embedding the bound application developer data and an identifier associated with the authenticated developer certificate in the test application license.
